(19) United States
(12) Patent Application Publication
(10) Pub. No.: US 2022/0195995 A1
(43) Pub. Date: Jun. 23, 2022

(54) WIND TURBINE

(71) Applicant: Wobben Properties GmbH, Aurich (DE)

(72) Inventors: Steffen Busemann, Bremen (DE); Sven Wollgam, Aurich (DE)

(21) Appl. No.: 17/552,960

(22) Filed: Dec. 16, 2021

(30) Foreign Application Priority Data
Dec. 18, 2020 (DE) 102020134078.8

(51) Int. Cl. F03D 80/60; F03D 80/80

(52) U.S. Cl. CPC F03D 80/60; F05B 2260/20; F05B 2220/706; F03D 80/88

(57) ABSTRACT

Thus provided is a wind turbine. The wind turbine has a nacelle with a first end and a second end, at least one air inlet and one nacelle housing with a nacelle interior. A first heat source in the form of an electric generator is provided, wherein the generator generates electrical energy and a first heat loss. A second heat source in the form of at least one electrical device is provided for converting the electrical energy generated by the generator in the nacelle interior, wherein the electrical devices generate a second heat loss, and are arranged in the nacelle housing. A cooling system with a liquid cooling system and an air cooling system for the first and second heat source is provided. An air treatment unit is provided in the nacelle interior, which has a droplet separator and a recirculating chiller. The droplet separator is designed to free the air flowing in through the air inlet of liquid droplets. The air cooling system has a fan or a fan set in the form of multiple fans in a single housing in the nacelle interior. The fan or the fan set generates an air flow in the direction of air flow within the nacelle, which flows around the recirculating chiller. The liquid cooling system has a coolant, and is coupled at least with the second heat source, and designed to cool the second heat source. The liquid cooling system is coupled with the recirculating chiller, which serves as a heat exchanger, wherein the air flow cools the recirculating chiller in the direction of air flow, which in turn cools the coolant. The air flow flows around the first and second heat source, and thus cools the first and second heat source.

### BACKGROUND

### Technical Field

The present invention relates to a wind turbine.

### Description of the Related Art

A wind turbine typically has a generator in a nacelle of the wind turbine, which converts kinetic energy into electrical energy. Electrical losses here come about, which are converted into heat losses. For this reason, it may be necessary to cool a generator of a wind turbine. In principle, air cooling or liquid cooling can be provided here.

In the priority substantiating German patent application, the German Patent and Trademark Office searched the following documents: DE 10 2010 000 756 A1, DE 10 2012 212 619 A1, US 2019/0 277 263 A1 and EP 3 527 820 B1.

### BRIEF SUMMARY

One or more embodiments are directed to a wind turbine as well as a wind turbine cooling system that enables an efficient cooling of a generator in a nacelle or in the rotor of the wind turbine.

A wind turbine is thus provided. The wind turbine has a nacelle with a first end and a second end, at least one air inlet as well as a nacelle housing with a nacelle interior. A first heat source in the form of an electric generator is provided, wherein the generator generates electrical energy and first heat loss. A second heat source in the form of at least one electrical device for converting the electrical energy generated by the generator is provided in the nacelle interior, wherein the electrical devices generate second heat loss, and are arranged in the nacelle housing. A cooling system with a liquid cooling system and an air cooling system for the first and second heat source is provided. An air treatment unit is provided in the nacelle interior, which has a droplet separator and a recirculating chiller. The droplet separator is designed to free the air flowing through the air inlet of liquid droplets. The air cooling system has a fan or a fan set in the form of multiple fans in a single housing in the nacelle interior. The fan or the fan set generates an air flow in the direction of air flow L within the nacelle, which flows around the recirculating chiller. The liquid cooling system has a coolant, and is coupled at least with the second heat source, and designed to cool the second heat source. The liquid cooling system is coupled with the recirculating chiller, which serves as a heat exchanger, wherein the air flow in the direction of air flow cools the recirculating chiller, which in turn cools the coolant. The air flow flows around the first and second heat source, and thus cools the first and second heat source.

According to one aspect of the present invention, a part of the generator, specifically the stator, is provided in or on the nacelle in a rotationally fixed manner. The rotor of the generator can then turn together with the aerodynamic rotor (i.e., the spinner and the rotor blades). The electric generator constitutes a first heat source or heat generator. Additional electrical devices that generate heat loss are provided within the nacelle. These electrical devices constitute a second heat source or a second set of heat sources. For example, these electrical devices are inverter cabinets for converting a direct voltage into an alternating voltage, transformers for transforming a voltage and/or a rectifier for rectifying the output voltage of the generator. In addition, the nacelle has a housing with an air inlet. The air inlet is optionally provided at an end of the nacelle facing away from the wind flow. The aerodynamic rotor with the spinner and the rotor blade is then provided on the other side, specifically on the side of the nacelle facing the wind flow. Provided inside of the nacelle is a fan or a fan set (with several fans) in a housing. The fan or the fan set are fixedly positioned within the nacelle. The fan can be provided in or on an air outlet, between the first and second heat source, or in the direction of air flow before the generator (and within the spinner).

Provided in the nacelle is an air treatment unit with a droplet separator and a recirculating chiller (as part of a liquid cooling system).

According to one aspect of the present invention, the fan or the fan set is the only active air flow generator for the cooling air flow within the nacelle. Let it be noted that further dedicated fans, e.g., for or within the generator or in or on further heat-generating units (e.g., power electronics, transformer), can be provided, but serve only to cool the respective components. For this purpose, these fans can be integrated into the housing.

The wind flow is generated by the wind, and first hits the aerodynamic rotor, and then the nacelle. The air flow for air cooling is generated by the fan, and flows within the nacelle from the air outlet through the nacelle, through the generator and through the air outlets toward the outside.

The direction of the air flow is opposite the direction of the wind flow.

The wind turbine cooler according to the invention constitutes a hybrid cooler in or on the nacelle, and has a liquid cooling system as well as an air cooling system. The liquid cooling system has a recirculating chiller as the heat exchanger. The recirculating chiller is located at an air flow of the air cooler generated by the fan. The recirculating chiller is preferably provided in the area of the air inlet as well as within the nacelle, so that the cold outside air sucked in through the air inlet can cool the recirculating chiller. As a consequence, the recirculating chiller serves as a heat exchanger or heat carrier, so that the coolant within the liquid cooling system heated by the first and/or second heat source is cooled by the outside air flowing in through the air inlet.

According to one aspect of the present disclosure, in particular the second heat source is at least partially cooled by the liquid cooling system.

According to another aspect of the present disclosure, a droplet separator is provided within the nacelle and in the area of the air inlet. The droplet separator serves to remove water droplets from inflowing outside air.

According to another aspect of the present disclosure, an air filter can be provided in the direction of air flow behind the droplet separator within the nacelle. The air filter is used to filter contaminants out of the air. Because the recirculating chiller of the liquid cooling system is provided within the nacelle and behind the air inlet, essentially the air flowing in completely through the air inlet passes through the recirculating chiller. As a result, an effective cooling of the coolant of the liquid cooling system can be achieved.

Another aspect here is that the inflowing air that passes through the heat exchanger in the form of the recirculating chiller is likewise heated. The air subsequently flows by the second heat source (electrical device, e.g., inverter cabinets, transformers, power electronics, rectifiers), and likewise cools these electrical devices. In particular, these electrical devices can be cooled by the liquid cooling system. In addition thereto, these electrical devices are likewise cooled by the air flow generated by the fan or the fan set within the nacelle. The air subsequently flows on and/or through the generator (stator, rotor), and cools the rotor and/or the stator of the generator. In addition thereto, a liquid cooling of the stator and/or the rotor can optionally take place.

At least one air outlet is provided in the area of the generator, in particular in the direction of air flow behind the generator. This at least one air outlet can be provided in or on a spinner or rotor head of the aerodynamic rotor. Alternatively thereto, the air outlet can lie on a gap between the rotor and the stator, which can be present due to the design.

A labyrinth can optionally be provided in or on the air outlet. This labyrinth can serve to prevent the penetration of water or dripping water.

As a consequence, the outside air is sucked in through the air inlet, flows through the recirculating chiller, the droplet separator, optionally the air filter, and then cools the second heat source. The air subsequently flows on or through the generator and cools the latter, so as to subsequently get to the outside through the air outlets.

As a consequence, the air cools the recirculating chiller (and thus the coolant flowing therein), the second heat source as well as the first heat source in the form of the electric generator, before the air gets to the outside through the air outlets.

According to one aspect of the present disclosure, both the electric generator and the power electronics for converting a direct voltage into an alternating voltage as well as an optional transformer are provided in the nacelle. This is advantageous, because no cable from the nacelle need be provided in the tower base, where the power electronics are otherwise usually provided. Such a cable is typically a medium voltage cable. Since the power electronics are now provided in the nacelle, only a high-voltage cable from the nacelle to the tower base is now provided. Let it here be noted that such a high-voltage cable requires less conductor material, which among other things leads to less power dissipation. This advantage is strengthened as the height of the nacelle increases, since an enlarged length of the voltage cable also leads to an enlarged power dissipation.

The transport of such a nacelle (with generator plus power electronics) is further advantageous, since the entire nacelle including the generator and power electronics can be transported preassembled to the construction site. This makes it possible to significantly reduce work at the construction site. In addition, a liquid cooling system in the nacelle can already be checked for tightness during preassembly, and provided with a corresponding coolant. In addition, the crane and setup times can be reduced.

According to one aspect of the disclosure, the output voltage of the nacelle can constitute an average voltage of >=1000 V (volts).

Additional configurations of the disclosure are the subject of the subclaims.

### BRIEF DESCRIPTION OF THE SEVERAL VIEWS OF THE DRAWINGS

Advantages and exemplary embodiments of the disclosure will be explained in more detail below with reference to the drawing.

FIG. 1 shows a schematic view of a wind turbine according to the disclosure,

FIG. 2 shows a schematic view of a nacelle of the wind turbine according to FIG. 1,

FIG. 3 shows a schematic view of a filtering of the inflowing air according to one aspect of the present disclosure,

FIG. 4A shows a schematic view of a nacelle according to an exemplary embodiment of the disclosure,

FIG. 4B shows the section A of FIG. 4A, and

FIGS. 5A and 5B each show a magnified view of the detail B of FIG. 4A.

### DETAILED DESCRIPTION

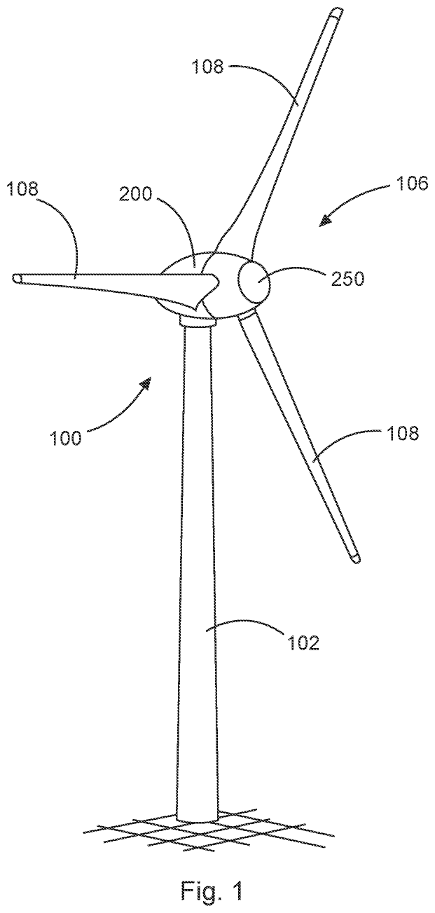

FIG. 1 shows a schematic view of a wind turbine according to one aspect of the present disclosure. The wind turbine 100 has a tower 102 and a nacelle 200 on the tower 102. An aerodynamic rotor 106 with three rotor blades 108 and a spinner 250 is provided on the nacelle 200. The spinner 250 and the nacelle 200 together comprise a housing, wherein the nacelle is fixed, and the spinner 250 rotates. During operation of the wind turbine, the aerodynamic rotor 106 is made to rotate by the wind, and thus also turns a rotor or runner of a generator, which is directly or indirectly coupled with the aerodynamic rotor 106. The electric generator is arranged in the nacelle 200, and generates electrical energy. The pitch angles of the rotor blades 108 can also be altered by pitch motors on the rotor blade roots of the respective rotor blades 108.

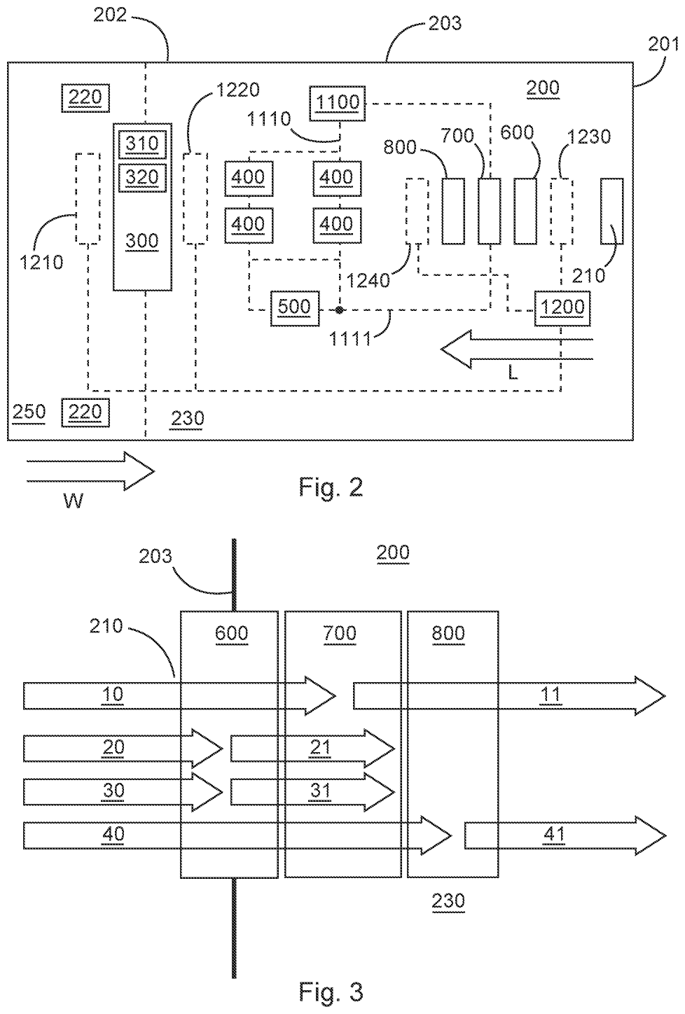

FIG. 2 shows a schematic view of a nacelle of the wind turbine according to FIG. 1. The nacelle 200 has an upwind end 202 and a downwind end 201. The nacelle 200 has a housing 203 and a nacelle interior 230. The nacelle 200 has an air inlet 210 on its downwind end 201. The air inlet 210 can be provided on downwind end of the nacelle, or in the area of the downwind end on the side of the nacelle 200. For example, an air treatment unit with a droplet separator 600, a recirculating chiller 700 and optionally an air filter 800 can be provided in the direction of wind flow before the air inlet 210. Further provided is a fan 910, 920, 940, 930, which generates an air flow L in a direction of air flow. The air sucked in through the air inlet 210 here flows through the air treatment unit with the droplet separator and the recirculating chiller 700 and to the upwind end 202 of the nacelle.

According to one aspect of the disclosure, the air inlet 210 can be provided laterally and in the downwind area of the nacelle. The air can flow from the air inlet 210 in the direction of air flow through the droplet separator 600, the recirculating chiller 700 and optionally the air filter 800.

Located within the nacelle is at least part (for example the stator) of an electric generator 300. One part of the generator 300 can be located in the spinner 250. This electric generator generates heat loss, and constitutes a first heat source or a first heat generator. At least one first electrical device 400 is provided between the electric generator 300 and the recirculating chiller 700. The at least one electrical device 400 generates heat loss, and constitutes a second heat source or a second heat generator. The electrical device 400 can be configured as a power electronics device, a rectifier, an inverter, a converter and/or as a transformer.

Therefore, two heat sources are present in the heat sources, specifically the first heat source 300 and the second heat source 400, 500. These two heat sources each generate a heat loss, which can become so large that the first and/or second heat source 300, 400, 500 must be cooled.

In order to cool the first and/or second heat source, the wind turbine has a cooling system 1000. This cooling system is configured as a hybrid cooling system, and has a liquid cooling system 1100 and an air cooling system 1200. The air cooling system 1200 has a fan or a fan set 910, 920, 930, 940. The fan or the fan set 910-940 can be present at least at four positions within the nacelle of the wind turbine, and generates an air flow with a direction of air flow L opposite the direction of wind flow W. The direction of air flow L thus extends from the downwind end 201 of the nacelle to the upwind end 202 of the nacelle 200. As a consequence, the direction of flow is opposite to the direction of wind flow outside of the nacelle. The air flow hence passes by the recirculating chiller 700, the at least one electrical device 400 and the generator 300. The nacelle further has at least one air outlet 220 in the area of the first end 202 of the nacelle 200. The nacelle 200 has a housing 203, which encloses a nacelle interior 230.

According to the disclosure, the air flow within the furnace is generated by the fan or the one fan set. A liquid cooling system 1100 is provided within the nacelle 200. The liquid cooling system 1100 has cooling lines 1110, which are coupled with the electrical devices 400, so as to cool the latter. As a consequence, a cooling liquid 1111 flows through the cooling lines 1110 and cools the electrical devices 400. The coolant heated as a result then flows through the recirculating chiller 700 and via another line 1110 back to the cooling system 1100. The recirculating chiller 700 thus serves as a heat exchanger, and is intended to cool the coolant 1111 located in the lines 1110. This is done by the air flow.

According to one aspect of the present disclosure, the generator can optionally be at least partially coupled with the liquid cooling system, so that the generator is at least partially cooled by the coolant 1111 in the cooling system 1100.

According to one aspect of the present disclosure, a cooling system is thus provided for a wind turbine, wherein the cooling system is a hybrid cooling system, which has liquid cooling and air cooling. The air cooling is provided by a fan or a fan set comprising a plurality of fans. Therefore, the fan or fan set is not arranged at several positions within the nacelle, but rather only has one position. An air fan comprises a fan unit, wherein several fans are provided within a housing. As a consequence, the fan can be configured as an individual fan or as a fan set within a shared housing.

The droplet separator 600 enables a mechanical separating process based in particular on centrifugal forces, so as to separate water particles or liquid particles from the inflowing air. Liquid particles with small droplet sizes (<20 μm (microns)) can here not be removed from the inflowing air. The separated liquid particles or those removed by the droplet separator can evaporate on the recirculating chiller 70 as the result of heating. Solids (salt, sand, etc.) present in the liquid can here be crystalized. As a consequence, the recirculating chiller 700 enables a thermal separation process.

The solids crystalized out of the liquid can be filtered out by the ensuing air filter.

Therefore, the air becomes preconditioned (liquid particles are removed by means of the droplet separator and solids are removed by the air filter) in the air flow before the air hits the electrical devices.

FIG. 3 shows a schematic view of how the inflowing air is filtered according to one aspect of the present disclosure. According to one aspect of the present disclosure, outside air 10 passes through an air inlet 210 (at the downwind end or laterally on the nacelle in the area of the downwind end) into the interior 230 of the nacelle, and hits the droplet separator 600, where water and moisture are removed from the air. Therefore, the air only has a residual moisture 21 and solids or solid particles dissolved in the air. The recirculating chiller 700 heats the inflowing air, wherein the liquid particles, which were not removed from the air by the droplet separator (for example, because they are too small), evaporate, so that solids present in the liquid can crystalize out. The recirculating chiller 700 serves as a heat exchanger, so that the outside air is heated to a prewarmed air flow 11. Solids 40 (e.g., sand, dust, etc.) in the outside air can be filtered by the air filter 800, for example so that only fine dust particles 41 that are <20 μm remain.

As a consequence, the combination of a droplet separator, the recirculating chiller and the air filter makes it possible to air cool the generator via triple air treatment.

The nacelle essentially has the at least one air inlet and the at least one air outlet. This makes it possible to ensure that the air within the nacelle is essentially free of water particles and moisture, and also essentially free of other particles in the air. The air treatment required for this purpose can then be used to both cool the generator and to cool the electrical device within the nacelle.

The cooling system can provide an increase in air quality via a pre-dried and desalted air. A penetration of coarse moisture, for example snow or fog, can further be prevented. In addition, the number of required components can be reduced.

If the fan is not provided on the second end of the nacelle as per usual, but rather within the nacelle, this can contribute to a significant reduction in sound emission.

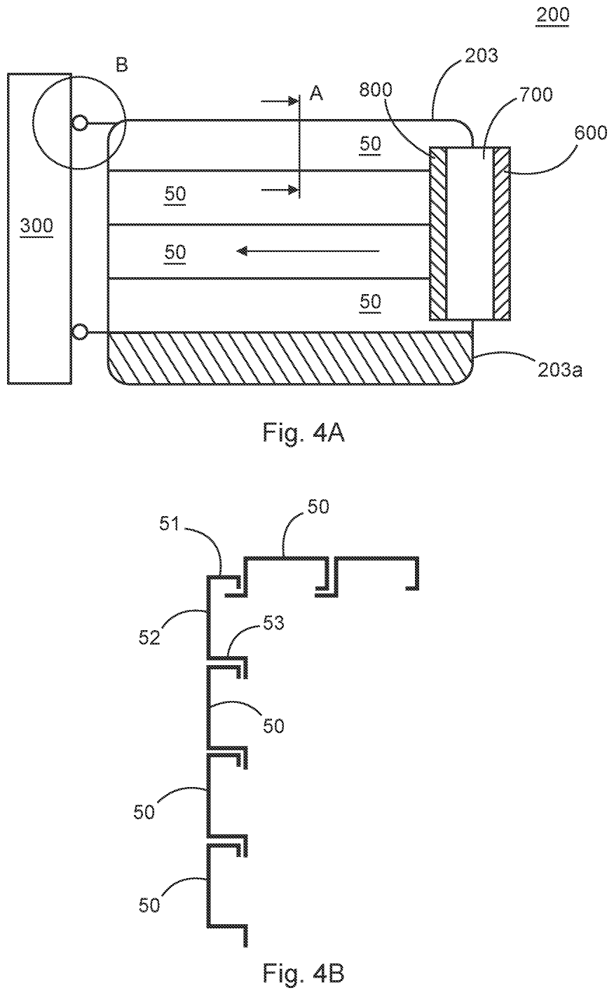

FIG. 4A shows a schematic view of a nacelle according to an exemplary embodiment of the disclosure. The nacelle 200 has a nacelle housing 203 with a nacelle floor 203a, which is configured in the form of a collecting tray. The nacelle housing 203 further has a plurality of cassette elements 50, which together at least partially comprise the nacelle housing. The cassette elements or cladding cassettes 50 can overlap each other, so that a nacelle housing 203 can be provided with a sufficient seal.

FIG. 4B shows the section A of FIG. 4A. Several cassette elements or cladding cassettes 50 are here provided, which are fastened to each other or abut against each other, so as to achieve a seal of the nacelle housing 203. A cladding cassette or a cassette element 50 can here have a first end 51, a middle section 52 and a second end 53. The first and second end 51, 52 are here provided at an angle of 90° to the middle element 52, for example. For example, a first end 51 of a cladding cassette 50 can abut against a second end 53 of another cladding cassette 50, so as to form at least a part of the nacelle housing 203.

The configuration of the first and second end 51, 53 can ensure that the cassette elements or cladding cassettes abut each other so tightly that the nacelle housing also has enough of a seal. This is advantageous in particular to prevent the air flow L generated by the fans from being able to leak out via the connecting points of the cassette elements 50. In addition, this also makes it possible to prevent unpurified outside air from being able to penetrate into the nacelle interior.

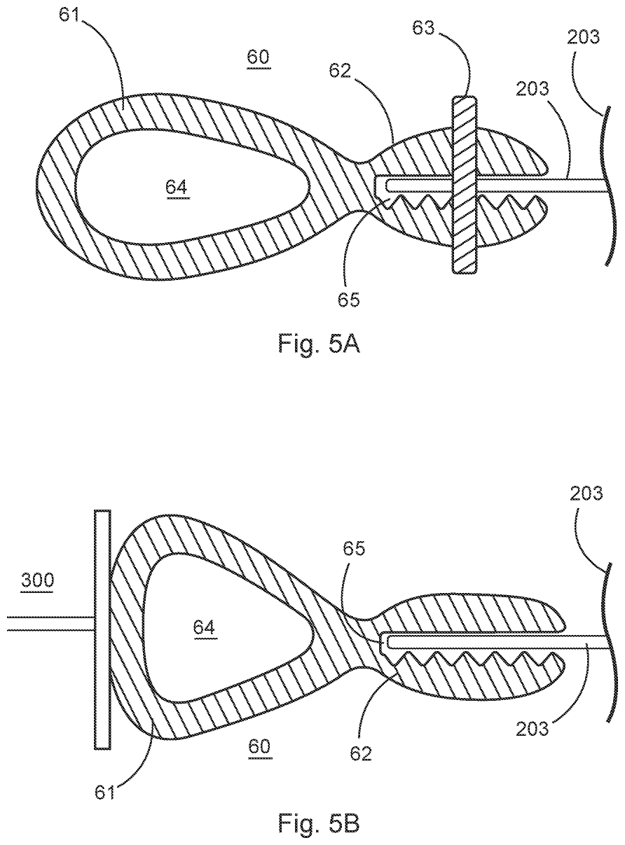

FIGS. 5A and 5B each show a magnified view of the detail B from FIG. 4A. In particular, detail B shows the seal between the nacelle and the generator housing. According to one aspect of the present disclosure, a bellows seal is provided between the housing of the generator and the nacelle housing. The bellows seal is preferably fastened to the nacelle cladding on the butt end. The compressible bellows can fit snug against the surface of the generator housing, so as to seal the transition between the nacelle housing and generator.

The bellows seal 60 has a first and second end 61, 62. The middle of the first end 61 has a hollow space 64, and can be compressed on contact, as shown on FIG. 5B. The second end 62 has a recess 65, which takes up part of the nacelle housing 203. The second end 62 can optionally be fastened to the nacelle housing 203 by means of a fastening unit 63 (e.g., a clamp or rivet). As evident on FIG. 5B, the first end 61 of the bellows seal 60 can abut against the generator 300 (or its housing) in the compressed state, so as to seal the transition between the nacelle housing and generator.

The two aforementioned measures (configuring the nacelle housing with cassette elements and sealing the transition between the generator housing and nacelle) can result in the nacelle and the transition from the nacelle to the generator having enough tightness, so that the treated air flow can flow through the nacelle to the generator. In addition, untreated outside air is prevented from being able to get inside of the nacelle.

According to another aspect of the present disclosure, the fan can be operated in such a way that an excess pressure prevails in the nacelle interior, so as to prevent untreated outside air from being able to get inside.

The nacelle floor 203a designed as a collecting tray is advantageous, because it can be used to reliably collect exiting liquid, for example the coolant. As a result, coolant can be prevented from exiting during a leak and running out of the nacelle. This also enables compliance with stricter environmental requirements.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wind turbine, comprising:
a nacelle having a first end, a second end, at least one air inlet, a nacelle housing, and a nacelle interior,
a first heat source comprising an electric generator, wherein the electric generator generates electrical energy and a first heat loss,
a second heat source comprising an electrical device configured to convert electrical energy generated by the generator in the nacelle interior, wherein the electrical device generates a second heat loss, wherein the electrical device is arranged in the nacelle housing,
a cooling system with a liquid cooling system and an air cooling system configured to cool the first and second heat source, and
an air treatment unit in the nacelle interior, wherein the air treatment unit has a droplet separator and a recirculating chiller,
wherein the droplet separator is configured to remove liquid droplets from air flowing in through the air inlet,
wherein the air cooling system has a fan or a fan set comprising a plurality fans in a single housing in the nacelle interior,
wherein the fan or the fan set generates an air flow in a direction of air flow within the nacelle interior, wherein the air flow flows around the recirculating chiller,
wherein the liquid cooling system has a coolant and is coupled to the second heat source and configured to cool the second heat source,
wherein the liquid cooling system is coupled with the recirculating chiller, which serves as a heat exchanger, wherein the air flow cools the recirculating chiller in the direction of air flow, thereby cooling the coolant, and
wherein the air flow flows around the first and second heat sources thereby cooling the first and second heat sources.

2. The wind turbine according to claim 1, wherein the air treatment unit has an air filter in the direction of air flow behind the recirculating chiller, wherein the air filter is configured to filter solids from air at least partially freed of water and liquid droplets by the droplet separator.

3. The wind turbine according to claim 1, wherein the nacelle housing has a nacelle floor that is a collecting tray, and a plurality of cassette elements.

4. The wind turbine according to claim 1, wherein the wind turbine has a generator and a seal between the nacelle housing and the generator.

5. The wind turbine according to claim 1, wherein the recirculating chiller is a first recirculating chiller, the wind turbine comprising a second recirculating chiller external to the nacelle housing, wherein the second recirculating chiller is cooled with the liquid cooling system, wherein coolant flows through the second recirculating chiller.

6. A method for cooling first and second heat sources in a wind turbine nacelle, wherein the nacelle has a first end, a second end, at least one air inlet, and a nacelle housing with a nacelle interior,
wherein the first heat source is an electric generator in the nacelle, wherein the generator generates electrical energy and first heat loss,
wherein the second heat source is at least one electrical device for converting the electrical energy generated by the generator in the nacelle interior, wherein the at least one electrical device generates second heat loss and is arranged in the nacelle housing,
wherein a cooling system with a liquid cooling system and an air cooling system for the first and second heat sources is provided in the nacelle housing,
wherein an air treatment unit is provided in the nacelle interior and has a droplet separator and a recirculating chiller,
wherein the droplet separator is configured to free the air flowing through the air inlet of liquid droplets,
wherein the air cooling system has a fan or a fan set comprising a plurality of fans in a single housing in the nacelle interior, the method comprising:
generating an air flow in a direction of air flow within the nacelle through the fan or the fan set, wherein the air flow flows around the recirculating chiller, and
cooling the second heat source via the liquid cooling system, wherein the liquid cooling system has a coolant coupled with the second heat source,
wherein the liquid cooling system is coupled with the recirculating chiller,
wherein the recirculating chiller serves as a heat exchanger, wherein the air flow in the direction of air flow cools the recirculating chiller thereby cooling the coolant, and
wherein the air flow flows around the first and second heat sources and cools the first and second heat sources.
